(19) United States
(12) Patent Application Publication
(10) Pub. No.: US 2026/0004398 A1
(43) Pub. Date: Jan. 1, 2026

(54) SYSTEM AND METHOD FOR ENHANCING SEISMIC IMAGES

(71) Applicant: SAUDI ARABIAN OIL COMPANY, Dhahran (SA)

(72) Inventors: Bingbing SUN, Dhahran (SA); Abdulmohsen M. ALI, Dhahran (SA); Yazeed K. ALTOWAIRQI, Dhahran (SA)

(73) Assignee: SAUDI ARABIAN OIL COMPANY, Dhahran (SA)

(21) Appl. No.: 18/757,210

(22) Filed: Jun. 27, 2024

(51) Int. Cl. G06T 3/4053

(52) U.S. Cl. CPC G06T 3/4053

(57) ABSTRACT

Systems and methods are disclosed relating to image enhancement. In an example, a first training of a machine learning (ML) algorithm can be implemented using a synthetic training dataset to provide a first model. The synthetic training dataset can include low-resolution and high-resolution synthetic image pairs. A second training of the ML algorithm can be implemented using a real training dataset and an output of the first model to provide a second model. The real training dataset can include real low-resolution images. A low-resolution image can be enhanced using the second model to provide an enhanced image of the low-resolution image.

### FIELD OF THE DISCLOSURE

This disclosure relates to a system and method for training a model and use of the model for enhancing a resolution of an image, such as a seismic image.

### BACKGROUND OF THE DISCLOSURE

Seismic imaging or tomography is a procedure for estimating an earth's rock parameters from seismic data. These rock parameters can be represented by a spatial distribution of, e.g., P-wave velocity, S-wave velocity, porosity, density, or anisotropic parameters. A result of inversion can be graphically presented as a 2-D or 3-D grid of pixels, where each pixel can contain a value of a model parameter of interest. Such tomograms can be used to estimate a geometry and lithology of geologic layers, and can help exploration geophysicists and earthquake seismologists understand an evolution of the earth's interior.

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

According to an embodiment, a method can include implementing a first training of a machine learning (ML) algorithm using a synthetic training dataset to provide a first model. The synthetic training dataset can include low-resolution and high-resolution synthetic image pairs. The method can further include implementing a second training of the ML algorithm using a real training dataset and an output of the first model to provide a second model. The real training dataset can include real low-resolution images. The method can further include enhancing a low-resolution image using the second model to provide an enhanced image of the low-resolution image.

According to another embodiment, a system can include one or more computing platforms configured to train a neural network (NN) algorithm using a diffusion process based on a synthetic training dataset to provide a first NN model. The synthetic training dataset can include low-resolution and high-resolution synthetic seismic image pairs. The one or more computing platforms can be further configured to train the NN algorithm using the diffusion process based on a real training dataset and an output of the first NN model to provide a second model. The real training dataset can include real low-resolution seismic training images. The one or more computing platforms can be further configured to transform a low-resolution seismic image using the second model to a high-resolution seismic image image.

In yet another embodiment, a method can include implementing a first training of an ML algorithm using a diffusion process based on a synthetic training dataset to provide a first model. The synthetic training dataset can include low-resolution and high-resolution synthetic image pairs. The diffusion process can be based on a Brownian bridge diffusion model (BBDM). The method can further include implementing a second training of the ML algorithm using a real training dataset and an output of the first model to provide a second model for enhancing a low-resolution image to a high-resolution image. The real training dataset can include low-resolution training images.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is an example of a block diagram of a seismic image enhancer training tool.

FIG. 2 is an example of a block diagram of a system for training a teacher neural network (NN) algorithm using the seismic image enhancer training tool, as shown in FIG. 1.

FIG. 3 is an example of a block diagram of a system for training a student NN algorithm using the seismic image enhancer training tool, as shown in FIG. 1.

FIG. 4 is an example of a synthetic training dataset.

FIG. 5 is an example of a real training dataset and corresponding output from a teacher NN model.

FIG. 6 is an example of a low-resolution two-dimensional (2D) inline seismic image.

FIG. 7 is an example of a high-resolution 2D inline seismic image.

FIG. 8 is another example of a high-resolution 2D inline seismic image.

FIG. 9 is an example of a spectrum comparing low-resolution and high-resolution 2D inline seismic images.

FIG. 10 is an example of a method for providing a trained real image enhancement model.

FIG. 11 is an example of a method of enhancing a low-resolution seismic image.

FIG. 12 is a block diagram of a system that can be used to perform one or more methods according to an aspect of the present disclosure.

FIG. 13 is an example of a cloud computing environment that can be used to perform one or more methods according to an aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

The present disclosure relates to machine learning (ML) training for seismic image enhancement and uses thereof. Seismic imaging serves as a tool for understanding complex geological formations and distribution of resources (e.g., hydrocarbons) beneath a planetary surface, such as Earth. An efficacy of seismic images is reduced by limitations in resolution, stemming from challenges encountered during seismic data acquisition and processing. This is because sensors can only be used at a surface within a limited area. A velocity model of a subsurface is difficult to obtain and thus a seismic image can become distorted due to inaccuracy of the velocity model in migration. A resolution of seismic images impacts an accuracy of geological analyses and thus quality seismic images reduce or eliminate uncertainties in seismic interpretation. Techniques have been developed to increase a resolution of seismic images to improve a clarity, detail and/or fidelity of seismic images produced through seismic data acquisition and processing. Such techniques are used to make seismic images clearer and detailed so that geological structures and distribution of resources can be better understood beneath the Earth's surface. Example techniques include seismic deconvolution and sparse spike inversion. Seismic deconvolution involves applying a mathematical operation to seismic data to attempt to remove effects of a seismic wavelet. By doing so, seismic deconvolution enhances a clarity of subsurface reflections and improves a resolution of seismic images. Seismic deconvolution is sensitive to noise levels in seismic data, and improper application can lead to artifacts or false features in resulting seismic images. Additionally, seismic deconvolution requires careful calibration and parameter tuning to achieve optimal results.

Sparse spike inversion is a technique used to enhance seismic images by exploiting a sparsity of seismic reflectivity in the subsurface. Sparse spike inversion aims to recover a sparse representation of a reflectivity model from seismic data. Sparse spike inversion involves formulating a seismic inversion problem as a sparse optimization problem, where an objective is to find a sparsest representation of the reflectivity model that explains the observed seismic data. However, sparse spike inversion requires careful selection of regularization parameters and can be computationally demanding, particularly for large-scale seismic datasets. Additionally, sparse spike inversion relies on assumptions of sparsity and may not always accurately capture complex geological structures. Seismic deconvolution or sparse spike inversion have been employed to broaden the frequency spectrum of seismic images. While effective in scenarios with favorable signal-to-noise ratios (SNRs), these methods can fail when confronted with high levels of noise. Moreover, achieving resolution enhancement tailored to structural characteristics of geological formations requires considerable effort and resources.

Alternative techniques for enhancing seismic images have been used that incorporate ML techniques for improving seismic resolution. Such ML driven techniques use supervised learning and utilize convolutional neural networks (CNNs) to generate high-resolution images from their low-resolution counterparts. These “image-to-image” prediction models (referred to as “seismic image prediction models” herein) overlook prior information within a seismic image (low-resolution seismic image). Consequently, existing seismic image prediction models run a risk of overfitting because of being trained solely on synthetic datasets, and fail to generalize well to real-world seismic imaging scenarios. Generalization refers to an ability of an ML model (the seismic image prediction model) to accurately make predictions on new, unseen data that it has not been explicitly trained on. The synthetic datasets are artificially generated datasets that mimic certain aspects of real seismic data but may not fully capture complexities and nuances present in actual (or real) seismic images obtained from a field. Real-world seismic images are subject to various sources of noise, uncertainties in the subsurface, and other factors that may not be adequately represented in synthetic datasets. When the seismic image prediction model is trained solely on synthetic datasets, the seismic image prediction model can become overly specialized or “overfit” to characteristics of those datasets. This means that the seismic image prediction model can learn to perform well on the specific examples present in synthetic training data but struggle to generalize its learned patterns to new, unseen data from real-world seismic imaging scenarios. This can lead to inaccuracies, poor performance, or even failure when the seismic image prediction model is applied to actual seismic data collected in a field.

According to the examples herein, an ML framework (referred to as “a teacher-student knowledge distillation framework”) is disclosed that mitigates or eliminates the problems associated with existing seismic image prediction models. The ML framework can be used to provide a trained ML model that can provide predictions (e.g., high-resolution seismic images) at a greater degree of accuracy than the existing seismic image prediction models. For example, the ML framework can include a first NN algorithm referred to as a teacher NN algorithm and a second NN algorithm referred to as a student NN algorithm. The teacher NN algorithm can be trained on synthetic seismic image pairs to provide a trained teacher NN model, each pair including a low-resolution synthetic seismic image and a high-resolution synthetic seismic image. After training, the trained teacher NN model can be used to generate high-resolution images from low-resolution input images during a sampling process. The student NN algorithm can be trained based on real low-resolution seismic images and an output of the trained teacher NN model using it as a label for generating high-resolution seismic images. The student NN algorithm can be trained in a same or similar manner as the teacher NN algorithm to provide a trained student NN model. The trained student NN model can be used (deployed) for enhancing an image quality of low-resolution seismic images in one or more applications and/or uses thereof, such as disclosed herein.

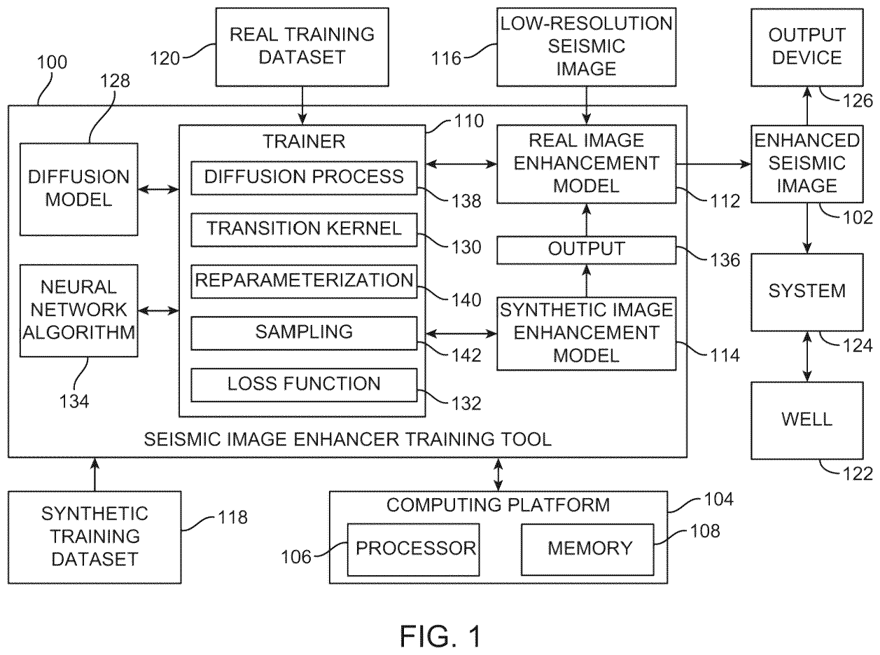

FIG. 1 is an example of a block diagram of a seismic image enhancer training tool 100. The term “enhancing”, and its derivatives, as used herein, can refer to transforming a low-resolution image to a high-resolution image. Examples are disclosed herein in which the tool 100 is used for training an ML model for seismic image enhancement; in other examples, the tool 100 can be used for training an ML for other types of image enhancement. In some examples, the tool 100 can employ a teacher-student knowledge distillation framework during training to provide a real-image enhancement model 112 that can transform (enhance an image quality) of seismic images, which can be referred to as enhanced seismic images. The tool 100 can be implemented using one or more modules, shown in block form in the drawings. The one or more modules can be in software or hardware form, or a combination thereof. In some examples, the tool 100 can be implemented as machine readable instructions for execution on a computing platform 104, as shown in FIG. 1. The computing platform 104 can include one or more computing devices selected from, for example, a desktop computer, a server, a controller, a blade, a mobile phone, a tablet, a laptop, a personal digital assistant (PDA), and the like.

The computing platform 104 can include a processor 106 and a memory 108. By way of example, the memory 108 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 106 can be implemented, for example, as one or more processor cores. The memory 108 can store machine-readable instructions (e.g., the tool 100) that can be retrieved and executed by the processor 106. Each of the processor 106 and the memory 108 can be implemented on a similar or a different computing platform. The computing platform 104 can be implemented in a cloud computing environment (for example, as disclosed herein) and thus on a cloud infrastructure. In such a situation, features of the computing platform 104 can be representative of a single instance of hardware or multiple instances of hardware executing across the multiple of instances (e.g., distributed) of hardware (e.g., computers, routers, memory, processors, or a combination thereof). Alternatively, the computing platform 104 can be implemented on a single dedicated server or workstation. In some examples, the tool 100 can be implemented as part of or integrated into reservoir software or platform, but in other instances, can be implemented as a stand-alone application/software (e.g., and can be invoked by software, a program, a routine, in other instances, invoked by a user).

The tool 100 includes a trainer 110 that can provide the real image enhancement model 112 and a synthetic image enhancement model 114. Each of the real and synthetic image enhancement models 112 and 114 is an instantiation of a machine learning (ML) model. An ML model represents what the ML algorithm has learned from a training process. The ML model is then utilized to make predictions on new, unseen data. Accordingly, the real image enhancement model 112 and the synthetic image enhancement model 114 are instantiations of a NN algorithm u_{θ}(xₜ, t) 134 trained according to one or more examples, as disclosed herein. The NN algorithm u_{θ}(xₜ, t) 134 can have a U-net, a transformer architecture, or can be based on a different type of architecture.

The tool 100 can provide the synthetic image enhancement model 114 based on a synthetic training dataset 118. For example, the trainer 110 can use the synthetic training data 118 to train the NN algorithm u_{θ}(xₜ, t) 134 to provide the synthetic image enhancement model 114. The trainer 110 can use real training dataset 120 and an output 136 of the synthetic image enhancement model 114 to train the NN algorithm u_{θ}(xₜ, t) 134 to provide the real image enhancement model 112. Initially, the trainer 110 trains the NN algorithm u_{θ}(xₜ, t) 134 to provide the synthetic image enhancement model 114 and then uses the synthetic image enhancement model 114 in training (or retraining) of the NN algorithm u_{θ}(xₜ, t) 134 to provide the real image enhancement model 112. The synthetic training data 118 includes synthetic seismic images pairs, wherein each pair includes a low-resolution synthetic seismic image (referred to herein as a low-resolution synthetic image) and a low-resolution synthetic seismic image (referred to herein as a high-resolution synthetic image). The real training dataset 120 includes real low-resolution seismic images (referred to herein as real low-resolution images). The term “real” as used herein in relation to an image (or seismic images) indicates that the image is generated based on data from a field and not synthetically generated.

For example, to train the NN algorithm u_{θ}(xₜ, t) 134 to provide the synthetic image enhancement model 114 and the real image enhancement model 112, the trainer 110 can employ a diffusion process 138. The diffusion process 138 can include a stochastic process to transform over time a high-resolution image (e.g., the high-resolution synthetic image during training of the synthetic image enhancement model 114, and/or the real high-resolution image during training of the real image enhancement model 112) into a low-resolution image (e.g., the low-resolution synthetic image during training of the synthetic image enhancement model 114, and/or the real low-resolution image during training of the real image enhancement model 112).

For example, there can be two phases. During a first phase, which is a training phase, a high-resolution image (x) can be converted into a lower-resolution version (y). Then, the NN algorithm u_{θ}(xₜ, t) 134 can be used to learn a representation of a probability distribution associated with this transformation (referred to as a learned transformation). In the second phase, which is an inference stage or application phase, the NN algorithm u_{θ}(xₜ, t) 134 that has been trained is provided with a low-resolution image (y) and the learned transformation is iteratively applied to reconstruct a high-resolution version of the image (x). The probability distribution associated with the transformation can represent an uncertainty or variability in the transformation process. For example, the probability distribution can represent a range of possible low-resolution images (y) that could result from converting a given high-resolution image (x). By learning this probability distribution using the NN algorithm u_{θ}(xₜ, t) 134, the NN algorithm u_{θ}(xₜ, t) 134 captures inherent uncertainty in the transformation from high-resolution to low-resolution images and can be referred to as the synthetic image enhancement model 114.

Thus, during the training phase, the NN algorithm u_{θ}(xₜ, t) 134 learns to approximate this probability distribution based on the synthetic training dataset 118, enabling the NN algorithm u_{θ}(xₜ, t) 134 to learn generation of low-resolution images from high-resolution images. During the inference or application phase, this learned probability distribution is utilized to iteratively reconstruct a high-resolution image from a given low-resolution input. The probability distribution guides an iterative reconstruction process, allowing for the generation of high-resolution images from low-resolution images.

For example, during training (e.g., of the synthetic image enhancement model 114 and the real image enhancement model 112), at each time step t of the diffusion process 138, a high-resolution image x is iteratively refined according to one or more constraints, such as input conditions. The diffusion process 138 can begin with receiving or receiving the high-resolution image x from the synthetic training data 118 and in other instances from the real training dataset 120. At a start, x₀ is set equal to the high-resolution image x. The term x₀ can represent an initial state of a low-resolution image before any transformations or refinements have occurred, which can be set to be equal to the high-resolution image x at the start of a diffusion process. Thus, x₀ is a starting point of the diffusion process 138, where the low-resolution image y initially matches the high- resolution image x before undergoing any transformations and/or enhancements through the diffusion process 138.

In some examples, the diffusion process 138 uses a diffusion model 128. The diffusion model 128 can be a probabilistic model that quantifies uncertainty by assigning probabilities to various outcomes or events. The diffusion model 128 can capture dependencies and structures present in data, allowing for generation of new samples that resemble observed data and making predictions or inferences about unseen data. Thus, the diffusion model 128 can be a statistical framework used to model uncertainty and make predictions based on probability distributions. In some examples, the diffusion model 128 is a Brownian Bridge Diffusion Model (BBDM). The diffusion model 128 provides a framework for the diffusion process 138 to consider an input condition, such as the low-resolution image y during processing. The diffusion model 128 can employ a Brownian bridge process, which is a Gaussian process that bridges a gap between low-resolution and high-resolution images. The Brownian bridge process considers the input condition as its destination and influences or controls the diffusion process 138 toward generating a high-resolution image that retains important features while reducing noise. By using the BBDM as part of the diffusion process 138, the diffusion process 138 can be influenced by an objective of the BBDM. The Brownian bridge process ensures that the diffusion process 138 can follow a specific path, maintaining certain characteristics throughout the transformation. For example, the Brownian bridge process can be used to preserve important features of the high-resolution synthetic seismic image while reducing noise to generate a low-resolution output.

For example, given a pair of datasets (y, x), where y represents the low-resolution image and x represents the high-resolution image, a forward diffusion process in the diffusion model 128 (e.g., the BBDM) can follow a Gaussian process. In some examples, the pair of datasets (y, x) is based on the synthetic training dataset 118, such as for generation of the synthetic image enhancement model 114, in other examples, the pair of datasets (y, x) is based on the real training dataset 120 and the output 136 of the synthetic image enhancement model 114. The synthetic image enhancement model 114 (a trained ML model) can provide a real high-resolution image as the output 136 based on a low-resolution image. Thus, the NN algorithm u_{θ}(xₜ, t) 134 is trained based on the real training dataset 120 and the output 136 to provide the real image enhancement model 112.

For example, the diffusion process 138 can be based on process parameters, which can include a transition kernel 130 and reparameterization 140. The transition kernel 130 can define a probabilistic relationship between a current state xₜ and a next state xₜ₊₁ in the diffusion process 138. The transition kernel 130 can include or be characterized by the following expression or equation:

$$q ( {x}_{t} \vert {x}_{0} , y ) = ( {x}_{t} ; ( 1 - {m}_{t} ) {x}_{0} + {m}_{t} y , {σ}_{t}^{2} I ) \qquad ( 1 )$$

wherein q(xₜ|x₀, y) denotes the transition kernel 130 from x₀ to xₜ, which can be a Gaussian, with a mean value (1−mₜ)x₀ and a covariance

$${σ}_{t}^{2}$$

l, I is an identity matrix, and T is a total number of time steps of the diffusion process 138 (e.g., a maximum duration of a sampling process).

In equation (1), the

$${σ}_{t}^{2}$$

variance parameter can ve set by the trainer 110 according to the following equation:

$${σ}_{t}^{2} = 1 - ( {( 1 - {m}_{t} )}^{2} + {m}_{t}^{2} ) = 2 ( {m}_{t} - {m}_{t}^{2} ) . \qquad ( 2 )$$

The definition of the variance parameter

$${σ}_{t}^{2}$$

is such that a noise tends to zero while achieving a maximum value of 0.5 in a middle of the Brownian bridge process. For example, for x₀=x and x_{T}=y, the BBDM bridges a gap between high-resolution and low-resolution images.

The transition kernel 130 can control how the diffusion process 138 evolves over time while evaluating the input condition provided by BBDM. The current state xₜ is a high-resolution image version at a given time step t during the diffusion process 138. At each time step t, the current state xₜ is a starting point for further transformation toward a final low-resolution seismic image y. The next state xₜ₊₁ is a lower resolution image at a subsequent time step t+1 during the diffusion process 138. The next state xₜ₊₁ can be obtained by evolving the current state xₜ based on the transition kernel 130, defining a probability between the current state xₜ and next state xₜ₊₁. Thus, the next state xₜ₊₁ is a result of applying the diffusion process 138 according to the Brownian bridge and the constraints imposed by the diffusion model 128 (e.g., the BBDM) to transform the current state xₜ toward the low-resolution image y.

The reparameterization 140 can include a method that can be used to express random variables in terms of deterministic variables and/or a random noise source. The reparameterization 140 is used by the trainer 110 to sample from a (simple) distribution (e.g., Gaussian) and provide one or more sampled distributions that follow a distribution specified by the transition kernel 130.

The reparameterization 140 can use the following expression or equation:

$${x}_{t} = ( 1 - {m}_{t} ) {x}_{0} + {m}_{t} y + {σ}_{t} ϵ ϵ ∼ 𝒩 ( 0 , I ) \qquad ( 3 )$$

The reparameterization 140 can be used to generate samples that evolve the current state xₜ (a current low-resolution image version of the high-resolution image x) toward the next state xₜ₊₁ according to the transition kernel 130 based on the constraints imposed by the BBDM (e.g., the diffusion model 128). The constraints imposed by the BBDM can include, but not limited to, preservation of features, smooth transition (e.g., to ensure that the transformation from the high-resolution image x to the low-resolution image y occurs smoothly and gradually over time), adherence to the Brownian bridge process (e.g., a Gaussian process that ensures smooth transition from one state to another), noise reduction (e.g., reducing noise and artifacts present in the high-resolution image x during the diffusion process 138), and/or consistency with an input condition (e.g., the BBDM considers the low-resolution image y as the input condition to influence the diffusion process 138).

For example, at each time step t, the trainer 110 can sample from a distribution to obtain a noise vector or latent variable ϵt. The distribution can be a Gaussian distribution N(0,1). The distribution can describe a likelihood of observing different values of a random variable and can be used to represent noise. The Gaussian distribution can be generated using a random number generator algorithm that can produce numbers that follow characteristics of this distribution. Various computational methods, such as the Box-Muller transform or the Marsaglia polar method, can be employed by the trainer 110 to generate random samples from the standard Gaussian distribution.

The trainer 110 can use the reparameterization 140 to transform the noise vector ϵₜ into a sample zₜ that follows a distribution defined by the current state xₜ. After transforming the noise vector ϵₜ into a sample zₜ that aligns with the current state xₜ, the reparameterization 140 can be used by the trainer 110 to evolve the sample zₜ toward the next state xₜ₊₁. The evolution can be constrained or according to the Brownian Bridge process and the probabilistic relationship defined by the transition kernel 130. Thus, by using reparameterization 140, the diffusion process 138 can explore a space of possible low-resolution images, leading to improved convergence and higher-quality results. Accordingly, by using the reparameterization 140, at each time step t, a distribution can be sampled to obtain the noise vector ϵₜ. This noise vector ϵₜ can be transformed by the trainer 110 into a sample that aligns with a distribution defined by the current state xₜ, and contributes to the generation of the next state xₜ₊₁ in the diffusion process 138.

Accordingly, at each time step t, the diffusion process 138 iteratively transforms a current high-resolution image xₜ towards the (final) low-resolution image y based on the diffusion model 128, the transition kernel 130 and the reparameterization (method) 140. In some examples, a total number of steps T for the diffusion process 138 can be selected or defined (e.g., based on user input, or by another software or routine). Thus there can be a number of time steps over a time step range defined from 0 to T, which can be represented as [0,T]. The trainer 110 can use sampling method 142, which is a time step sampling process for sampling time steps t from the interval [0,T]. The trainer 110 can use the sampling method 142 to select or identify specific points in time during the diffusion process 138 to perform computations and update (train) the NN algorithm u_{θ}(xₜ, t) 134. In some examples, the trainer 110 can uniformly sample the time steps t from the time step range [0,T]. Sampling uniformly means that each time step t within the time step range [0, T] has an equal probability of being selected.

At each time step t, the diffusion process 138 provides the current low-resolution image xₜ (based on the high-resolution image x from the synthetic training data 118). The trainer 110 can organize or form image pairs into image pair batches

$${( x , y )}_{i = 1}^{k}$$

based on the current low-resolution image xₜ generated at each time step t, where k represents a number of image pair batches. Each image pair batch can include the current low-resolution image xₜ (e.g., a lower resolution version of the high-resolution image x) and the high resolution image x (a target high resolution image) from the synthetic training data 118. For example, if T=10 (total time steps in the diffusion process 138) and trainer 110 chooses to sample 20 time steps uniformly from the interval [0, T], the trainer 110 can randomly select 20 time points within the diffusion process 138. Then, the trainer 110 can form batches of pairs of datasets (x, y) and use these batches, along with the sampled time steps, to train. the NN algorithm u_{θ}(xₜ, t) 134. The NN algorithm 134 can receive the image pair batches

$${( x , y )}_{i = 1}^{k}$$

and each sampled time step t. For each image pair batch, the NN algorithm u_{θ}(xₜ, t) 134 can use the current low-resolution image xₜ and an associated sampled time step t to provide a predicted high-resolution image. Thus, noise can be added during the diffusion process 138. The NN algorithm u_{θ}(xₜ, t) 134 can be trained to reverse and recover a low-resolution image. For example, during the training, xₜ is computed from (x,y) and noise by equation (3), and xₜ and the time step t (for distinguishing between different steps) can be inputted to the NN algorithm u_{θ}(xₜ, t) 134.

In some examples, the trainer 110 can define a loss function that measures the discrepancy between the predicted high-resolution image and a ground truth (e.g., the target high resolution image x). For example, the loss function can be a denoising based loss function 132. During training of the NN algorithm u_{θ}(xₜ, t) 134, the denoising-based loss function 132 can be minimized. The denoising based loss function 132 can included or be characterized by the following expression or equation:

$$Loss = ‖ x - {μ}_{θ} ( {x}_{t} = ( 1 - {m}_{t} ) x + {m}_{t} y + {σ}_{t} ϵ , t ) ‖ \qquad ( 4 )$$

Using the image pair batches

$${( x , y )}_{i = 1}^{k} ,$$

the trainer 110 can optimize parameters θ of the NN algorithm 134 u_{θ}(xₜ, t). The trainer 110 can use an optimization algorithm. During optimization, the trainer 110 can use the optimization algorithm to adjust the parameters θ of the NN algorithm 134 u_{θ}(xₜ, t) to minimize the denoising-based loss function 132 to improve an accuracy at which the NN algorithm u_{θ}(xₜ, t) 134 predict (or generates) high-resolution images. For example, the trainer 110 can use equation (4) to compute a loss, such as a Euclidean loss or mean squared error (MSE). The loss can be an L2 norm loss. The trainer can compute a gradient of the loss with respect to the parameters θ of the NN algorithm 134 u_{θ}(xₜ, t). For example, a gradient loss term

$$\frac{\partial Loss}{\partial θ}$$

can be calculated using an ML library, such as Pytorch or TensorFlow. The NN algorithm 134 u_{θ}(xₜ, t) can be updated (based on the image pair batches

$${( x , y )}_{i = 1}^{k} )$$

until a specific iteration number or accuracy is achieved for the model parameters

$$θ = θ - Y \frac{\partial Loss}{\partial θ} ,$$

wherein γ is a learning rate, e.g., a step length for updating the parameters θ. The parameters θ can include weights and/or biases.

In some examples, the trainer 110 can iteratively sample the time steps t over the time step range [0,T]. The trainer 110 can perform iterative sampling from x_{T}=y (the high resolution image) to x₀ (the low resolution image). However, due to an inherent randomness in the sampling process, achieving convergence can require hundreds or thousands of time steps t in some instances. In some examples, the trainer 110 can accelerate the diffusion sampling procedure. The trainer 110 can use a first-order DPM-solver. For example, the trainer 110 can set or define a sampling time step t_{τ}_{ᵢ}, where τ represents an index of each time step t, ranging from N−1 (a final time step t) to 0 (an initial time step t). The trainer 110 can provide a starting point for the diffusion process 138 to begin iteratively refining the low-resolution image y towards a higher resolution. The trainer 110 can set x_{τ}_{_{N−1}}=y such that at time step represented by τ_{N-1} (which is a sample time step t before a final sample time step t in the diffusion process 138), the low resolution image y is initialized to be equal to the high resolution image x.

The trainer 110 can initiate the iteration process of the high-resolution image x to start iterating from i=N−2 to i=0, wherein i is an index variable used for iteration. The trainer 110 can start iterating backwards from i=N−2 to i=0, where each iteration represents a step toward the low resolution image y. At each iteration, the trainer 110 can compute parameters m and σ using equations (1) and (2), which represent a mean and variance of the Gaussian distribution, respectively. Thus, the trainer 110 can compute at each iteration:

$${m}_{{t}_{{τ}_{i + 1}}} , {σ}_{{t}_{{τ}_{i + 1}}} , {m}_{{t}_{{τ}_{i}}} , {σ}_{{t}_{{τ}_{i}}} .$$

The variables

$${m}_{{t}_{{τ}_{i + 1}}} , {σ}_{{t}_{{τ}_{i + 1}}}$$

represent the mean and variance of the Gaussian distribution at the sample time step t_{τ}_{ᵢ₊₁}, which corresponds to a next time step after τᵢ₊₁ in the diffusion process 138. The variables

$${m}_{{t}_{{τ}_{i}}} , {σ}_{{t}_{{τ}_{i}}}$$

represent the mean and variance of the Gaussian distribution at the time step t_{τ}_{ᵢ}, corresponding to the current time step τᵢ in the diffusion process 138.

At each iteration, the trainer 110 can use the NN algorithm u_{θ}(xₜ, t) 134 with the current low-resolution image x_{τ}_{ᵢ₊₁} at the time step τᵢ₊₁ and its associated time step t to predict a next state x₀ of the diffusion process 138. The next state x₀ is the output of the NN algorithm u_{θ}(xₜ, t), representing a lower quality version of the current low-resolution image obtained at the time step τᵢ₊₁. At each iteration, the trainer 110 can calculate a noise term (vector) ∈ using a following expression or equation:

$$ϵ = ( {x}_{{τ}_{i + 1}} - {x}_{0} - ( y - {x}_{0} ) * {m}_{{t}_{{τ}_{i + 1}}} ) / {σ}_{{t}_{{τ}_{i + 1}}} , \qquad ( 5 )$$

wherein ∈ represents a noise term calculated at each iteration according to one or more examples herein, x_{τ}_{ᵢ₊₁} represents the low-resolution image at the time step τᵢ₊₁, x₀ represents the output of the NN algorithm u_{θ}(xₜ, t) 134 representing a lower image version of the low-resolution image obtained at the time step τᵢ₊₁, y is the low-resolution image, which serves as a reference point in the diffusion process 138, m represents a mean, and σ represents a variance at time step t_{τ}_{ᵢ₊₁}.

In some examples, at each iteration, the trainer 110 updates the current high-resolution image x_{τ}_{ᵢ} using the following expression or equation:

$${x}_{{τ}_{i}} = {x}_{0} + ( y - {x}_{0} ) * {m}_{{t}_{{τ}_{i}}} + {σ}_{{t}_{{τ}_{i}}} ϵ . \qquad ( 6 )$$

The expression (6) considers the noise term ∈, the low-resolution image y, the parameters m and σ. The resulting low-resolution image can reflect an influence of the noise term guided by the parameters m and σ. After completing all iterations of the sampling method 142, a final result represented by x_{τ}_{₀} can be outputted by the NN algorithm u_{θ}(xₜ, t) 134 and represents a predicted low-resolution image obtained at an end of the diffusion process 138. Thus, the trainer 110 can train the NN algorithm u_{θ}(xₜ, t) 134 to provide the synthetic image enhancement model 114.

In some examples, the synthetic image enhancement model 114 can be referred to as a teacher NN model. The teacher NN model is generated from training the NN algorithm u_{θ}(xₜ, t) 134 using synthetic image pairs and thus based on the synthetic training dataset 118. After providing the teacher NN model, the trainer 110 can train the NN algorithm u_{θ}(xₜ, t) 134 based on the real training dataset 120 to provide the real image enhancement model 112. The NN algorithm u_{θ}(xₜ, t) 134 can be trained based on the real training dataset 120 in a same or similar manner as the NN algorithm 134 was trained based on the synthetic training dataset 118 to provide the synthetic image enhancement model 114, but using the output 136 of the synthetic image enhancement model 114 as a label (a counterpart real high-resolution image for a real low-resolution of real training dataset 120).

Thus, the NN algorithm u_{θ}(xₜ, t) 134 can be initially trained using synthetic image pairs, where both the low-resolution and high-resolution synthetic images are synthetically generated. During this training phase, the high-resolution synthetic images act as ground truth labels for the low-resolution counterparts. This means that the NN algorithm u_{θ}(xₜ, t) 134 learns to map low-resolution input images to corresponding high-resolution versions. After training the NN algorithm u_{θ}(xₜ, t) 134 on the synthetic training dataset 118 to provide the synthetic image enhancement model 114, the NN algorithm u_{θ}(xₜ, t) 134 can be fine-tuned (or trained) using the real training dataset 120. However, since real high-resolution images typically do not have corresponding low-resolution versions, the synthetic image enhancement model 114, also known as the teacher model, is employed to generate a pseudo label (e.g., the output 136) for the real training dataset 120. Using the pseudo label (the real high-resolution image) provided by the synthetic image enhancement model 114 and the real training dataset 120, the trainer 110 can train the NN algorithm u_{θ}(xₜ, t) 134 in a same or similar manner as disclosed herein to provide the real image enhancement model 112.

Once trained, the real image enhancement model 112 can be used or deployed in a field (or application). For example, during use, the real image enhancement model 112 can receive a low-resolution seismic image 116 and predict (provide) an enhanced seismic image 102 of the low-resolution seismic image 116. In some examples, the enhanced seismic image 102 can be provided to a display 126 and rendered thereon. The display 126 can correspond to a display, as disclosed herein. Low-resolution seismic images are often acquired to survey underground structures and identify potential oil and gas reservoirs. However, these low-resolution images may not provide sufficient detail for accurate decision-making.

By enhancing the low-resolution seismic image 116 using the real image enhancement model 112, exploration and production teams can gain clearer insights into subsurface structures. For example, the enhanced seismic image 102 can provide clearer and more detailed information about subsurface formations, fault lines, and potential hydrocarbon reservoirs. Geoscientists and geophysicists can use the enhanced seismic image 102 to interpret geological features more accurately, leading to better-informed decisions regarding drilling locations and reservoir characterization. In some examples, the enhanced seismic image 102 can be used to help in delineating reservoir boundaries and identifying sweet spots within the reservoir where oil and gas accumulations are most concentrated. This information can be used for optimizing drilling and production strategies to maximize hydrocarbon recovery. In some examples, the enhanced seismic image 102 can reduce an uncertainty associated with subsurface conditions, enabling operators to mitigate exploration and production risks more effectively. By identifying potential drilling hazards such as faults, salt domes, or structural complexities, operators can plan drilling operations with greater confidence and safety. In some examples, the enhanced seismic image 102 can be used for reservoir monitoring and management during the production phase. By continuously monitoring changes in reservoir dynamics and fluid movement using time-lapse seismic imaging, operators can optimize production strategies, enhance oil recovery rates, and extend the life of the reservoir.

In some examples, the real image enhancement model 112 can be integrated into or communicate with an automated drilling system or reservoir management system, referred to as a system 124 in the example of FIG. 1. For example, in real-time drilling operations, the enhanced seismic image 102 could be used to adjust drilling parameters such as well trajectory or drilling speed with respect to a well 122 to avoid geological hazards or optimize well placement of the well 122 for maximum reservoir contact. In some instances, in reservoir management systems, the enhanced seismic image 102 could be used to inform decision-making algorithms for controlling injection rates, production schedules, or reservoir pressure to maximize hydrocarbon recovery while minimizing operational risks at the well 122.

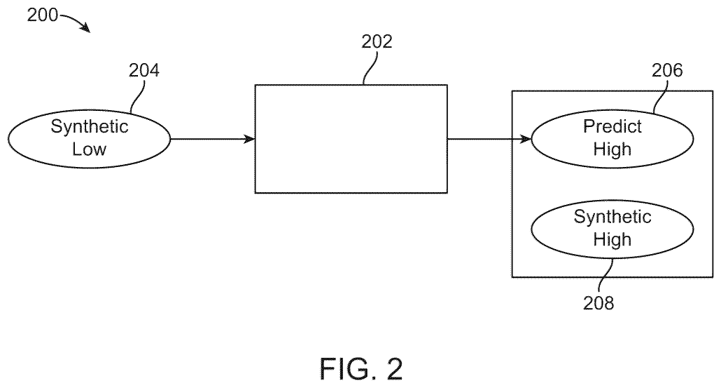

FIG. 2 is an example of a block diagram of a system 200 for training a teacher NN algorithm 202. For example, the tool 100, as shown in FIG. 1, can be used to train the teacher NN algorithm 202. Thus, reference can be made to one or more examples of FIG. 1 in the example of FIG. 2. In some instances, the teacher NN algorithm 202 corresponds to the NN algorithm 134, as shown in FIG. 1. For example, to train the teacher NN algorithm 202, synthetic paired datasets 204-206 can be used. The synthetic paired datasets include a low-resolution synthetic seismic image 204 and a synthetic high-resolution seismic image 206. The teacher NN algorithm 202 can be trained to provide (predict) a high-resolution synthetic seismic image 208 based on the low-resolution synthetic seismic image 204 according to one or more examples, as disclosed herein. After training, the teacher NN algorithm 202 can be deployed as a trained teacher NN model for training a student NN algorithm.

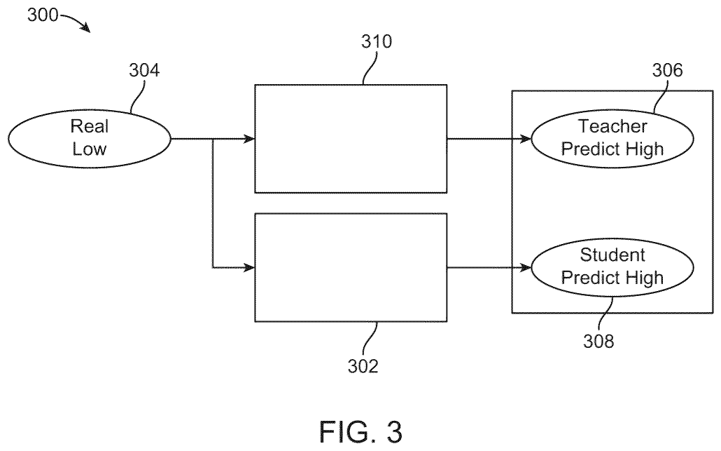

FIG. 3 is an example of a block diagram of a system 300 for training a student NN algorithm 302. For example, the tool 100, as shown in FIG. 1, can be used to train the student NN algorithm 302. Thus, reference can be made to one or more examples of FIGS. 1-2 in the example of FIG. 3. In some instances, the student NN algorithm 302 corresponds to the NN algorithm 134, as shown in FIG. 1. The student NN algorithm 302 can be trained according to one or more examples, as disclosed herein. For example, during training of the student NN algorithm 302, a real low-resolution seismic image 304 can be provided to the teacher NN model 310 and to the student NN algorithm 302. The teacher NN model 310 can provide a predicted real high-resolution seismic image 306. The predicted real high-resolution seismic 306 is an output (e.g., the output 136, as shown in FIG. 1) and can be used as a label for training the student NN algorithm 302. The student NN algorithm 302 can be trained based on the predicted real high-resolution seismic 306 generated by the teacher NN model 202 and the real low-resolution seismic image 304 to provide a predicted real high-resolution seismic image 308 according to one or more examples, as disclosed herein. After training, the student NN algorithm 302 can be deployed or used as a trained student NN model.

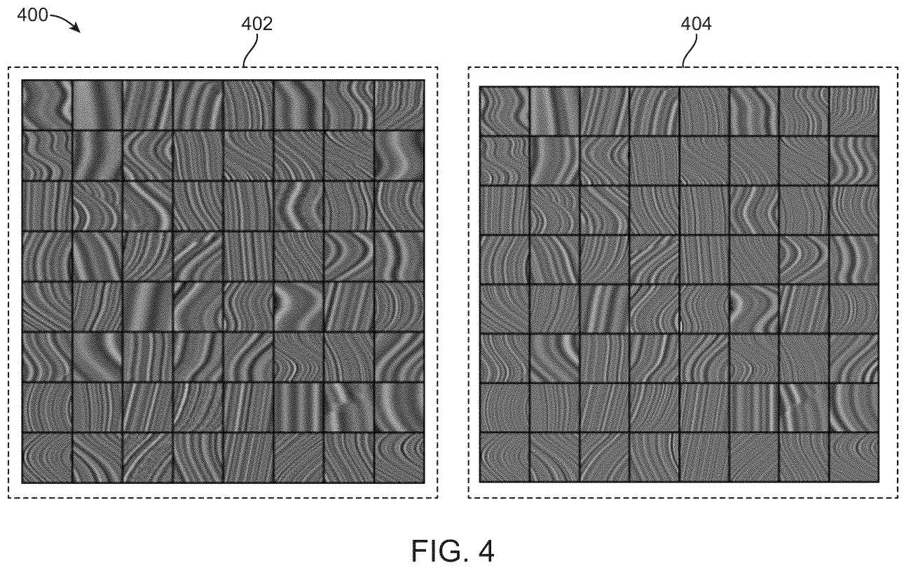

FIG. 4 is an example of a synthetic training dataset 400. The synthetic training dataset 400 can correspond to the synthetic training dataset 118, as shown in FIG. 1. Thus, reference can be made to one or more examples of FIGS. 1-3 in the example of FIG. 4. The synthetic training dataset 400 includes low-resolution synthetic image set 402 and a corresponding synthetic high-resolution image set 404. In the example of FIG. 4, the image sets 402 and 404 include 64 samples each, wherein each sample is 64 pixels by 64 pixels.

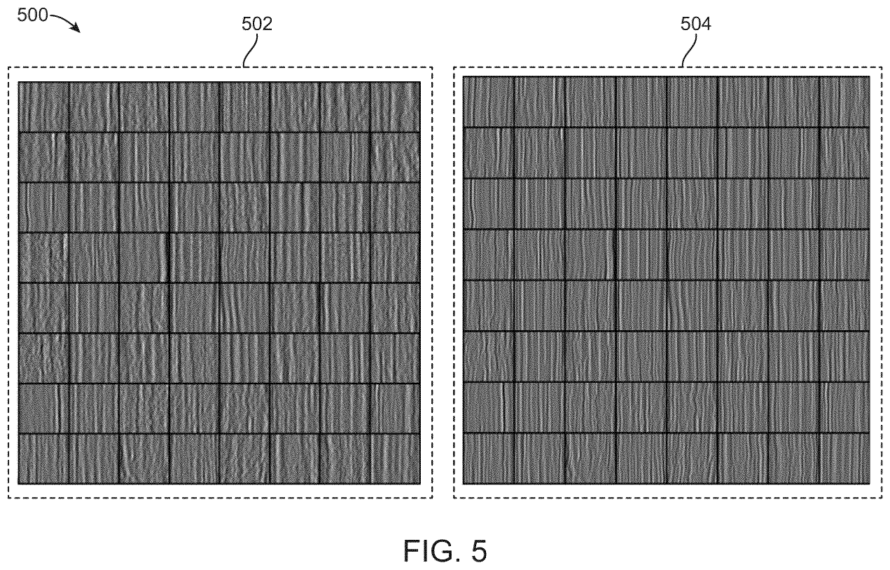

FIG. 5 is an example of a real training dataset 502 and corresponding output 504 from the teacher NN model (e.g., the synthetic image enhancement model 114), as disclosed herein. Thus, reference can be made to one or more examples of FIGS. 1-4 in the example of FIG. 5. The real training dataset 502 can correspond to the real training dataset 120, as shown in FIG. 1. As disclosed herein, the corresponding output 504 can be considered and used as a label for high-resolution image training of the student NN algorithm 302 to provide a trained student NN model (e.g., the real image enhancement model 112).

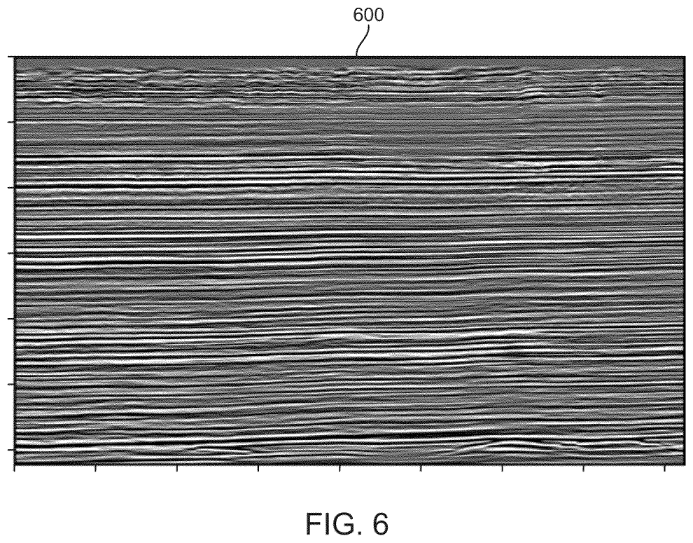

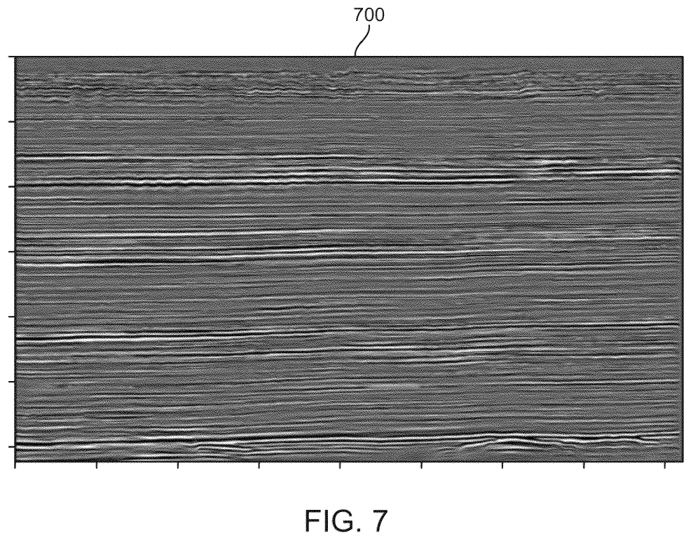

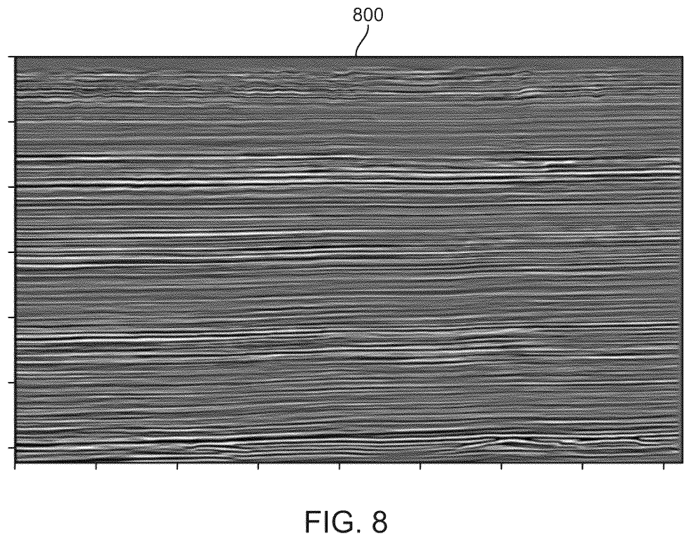

FIG. 6 is an example of a low-resolution two-dimensional (2D) inline seismic image 600, which in some instances can correspond to the low-resolution seismic image 116, as shown in FIG. 1. The low-resolution 2D inline seismic image 602 be enhanced by the synthetic image enhancement model 114 (the teacher NN model) to provide a high-resolution 2D inline seismic image 700, as shown in FIG. 7, and by the real-image enhancement model 112 (the student NN model) to provide a high-resolution 2D inline seismic image 800, as shown in FIG. 8. Thus, reference can be made to one or more examples of FIGS. 1-5 in the example of FIGS. 6-8. Comparing the high-resolution 2D inline seismic image 700 to the high-resolution 2D inline seismic image 800 it is apparent that the high-resolution 2D inline seismic image 800 is more reliable.

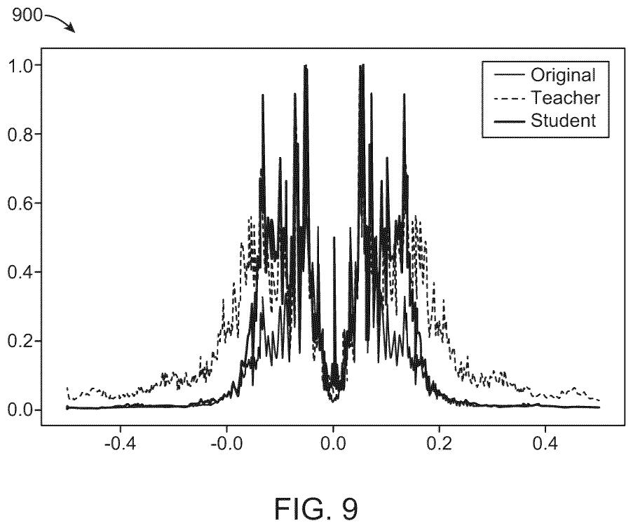

FIG. 9 is an example of a spectrum 900 comparing the low-resolution 2D inline seismic image 602, the high-resolution 2D inline seismic image 700, and the high-resolution 2D inline seismic image 800. A y-axis of the spectrum 900 represents an amplitude and an x-axis represents a ratio of a frequency and sampling frequency. As shown by the spectrum 900, the teacher NN model tends to be aggressive in producing high-resolution images, whereas the student NN model exhibits robustness, performing smoothing and artifact reduction. The spectrum 900 exhibits that the student NN model suppresses high-frequency components to a greater degree than the teacher NN model.

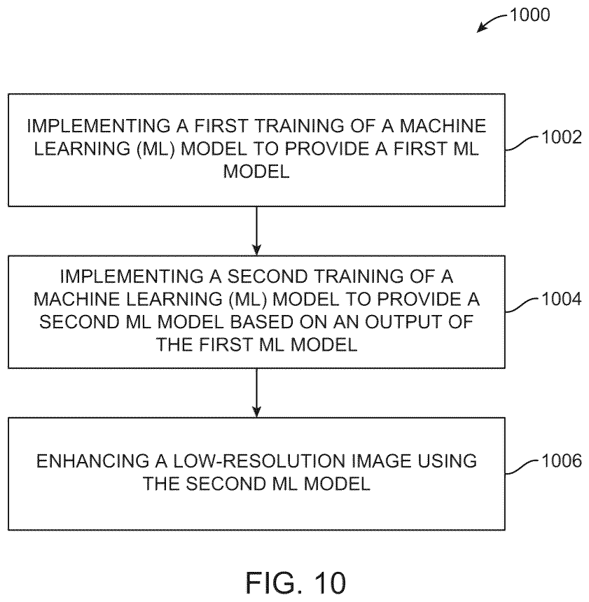

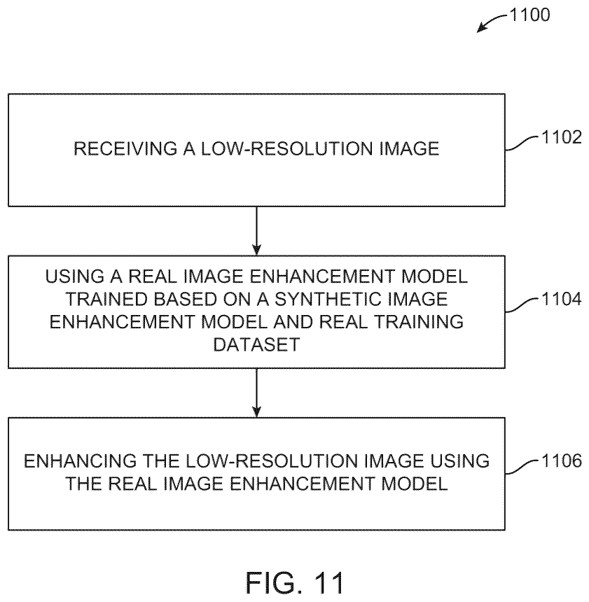

In view of the foregoing structural and functional features described above, an example method will be better appreciated with reference to FIGS. 10-11. While, for purposes of simplicity of explanation, the example methods of FIGS. 10-11 are shown and described as executing serially, it is to be understood and appreciated that the present example is not limited by the illustrated order, as some actions could in other examples occur in different orders, multiple times and/or concurrently from that shown and disclosed herein. Moreover, it is not necessary that all described actions be performed to implement the methods.

FIG. 10 is an example of a method 1000 for providing a trained real image enhancement model, such as the real image enhancement model 112, as shown in FIG. 1. Thus, reference can be made to one or more examples of FIG. 1-9 in the example of FIG. 10. One or more steps of the method 1000 can be implemented by the tool 100, as shown in FIG. 1. The method 1000 can begin at 1002 by implementing a first training of an ML algorithm (e.g., the NN algorithm 134, as shown in FIG. 1) using a synthetic training dataset (e.g., the synthetic training dataset 118, as shown in FIG. 1) to provide a first model (e.g., the synthetic image enhancement model 114, as shown in FIG. 1). The synthetic training dataset can include low-resolution and high-resolution synthetic image pairs. At 1004, a second training of the ML algorithm can be implemented using a real training dataset (e.g., the real training dataset 120, as shown in FIG. 1) and an output (e.g., the output 136, as shown in FIG. 1) of the first model to provide a second model (e.g., the real image enhancement model 112, as shown in FIG. 1). The real training dataset can include real low-resolution images. At 1006, a low-resolution image (e.g., the low-resolution seismic image 116, as shown in FIG. 1) can be enhanced using the second model to provide an enhanced image of the low-resolution image (e.g., the enhanced seismic image 102, as shown in FIG. 1).

FIG. 11 is an example of a method 1100 of enhancing a low-resolution seismic image, such as the low-resolution seismic image 116, as shown in FIG. 1. Thus, reference can be made to one or more examples of FIG. 1-10 in the example of FIG. 11. The method 1100 can begin at 1102 by receiving a low-resolution image (e.g., the low-resolution seismic image 116, as shown in FIG. 1). At 1104, using a real image enhancement model (e.g., the real image enhancement model 112, as shown in FIG. 1) trained based on a synthetic image enhancement model (e.g., synthetic image enhancement model 114, as shown in FIG. 1) and a real training dataset (e.g., the real training dataset 120, as shown in FIG. 1). The synthetic image enhancement model can be trained using a diffusion process and based on a synthetic training dataset (e.g., the synthetic training dataset 118, as shown in FIG. 1) that includes low-resolution and high-resolution synthetic image pairs. At 1106, the low-resolution image (e.g., the low-resolution seismic image 116, as shown in FIG. 1) can be enhanced using the real image enhancement model to provide an enhanced image of the low-resolution image (e.g., the enhanced seismic image 102, as shown in FIG. 1)

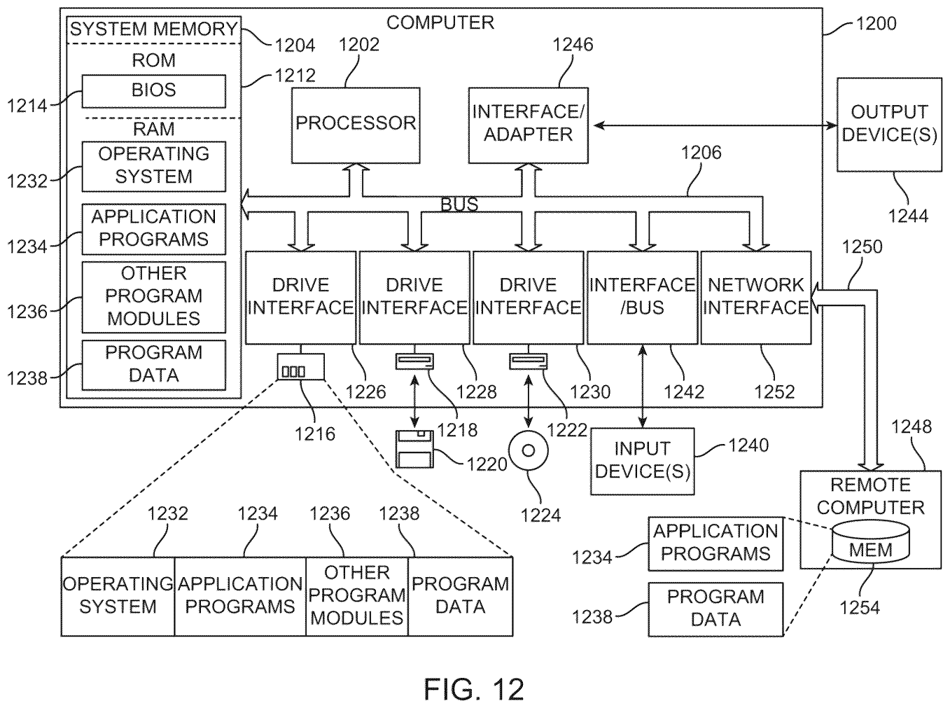

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 12. Thus, reference can be made to one or more examples of FIGS. 1-11 in the example of FIG. 12.

In this regard, FIG. 12 illustrates one example of a computer system 1200 that can be employed to execute one or more embodiments of the present disclosure. Computer system 1200 can be implemented on one or more general purpose networked computer systems, embedded computer systems, routers, switches, server devices, client devices, various intermediate devices/nodes, or standalone computer systems. Additionally, computer system 1200 can be implemented on various mobile clients such as, for example, a personal digital assistant (PDA), laptop computer, pager, and the like, provided it includes sufficient processing capabilities.

Computer system 1200 includes processing unit 1202, system memory 1204, and system bus 1206 that couples various system components, including the system memory 1204, to processing unit 1202. Dual microprocessors and other multi-processor architectures also can be used as processing unit 1202. System bus 1206 may be any of several types of bus structure including a memory bus or memory controller, a peripheral bus, and a local bus using any of a variety of bus architectures. System memory 1204 includes read only memory (ROM) 1210 and random access memory (RAM) 1212. A basic input/output system (BIOS) 1214 can reside in ROM 1212 containing the basic routines that help to transfer information among elements within computer system 1200.

Computer system 1200 can include a hard disk drive 1216, magnetic disk drive 1218, e.g., to read from or write to removable disk 1212, and an optical disk drive 1222, e.g., for reading CD-ROM disk 1224 or to read from or write to other optical media. Hard disk drive 1216, magnetic disk drive 1218, and optical disk drive 1222 are connected to system bus 1206 by a hard disk drive interface 1226, a magnetic disk drive interface 1228, and an optical drive interface 1230, respectively. The drives and associated computer-readable media provide nonvolatile storage of data, data structures, and computer-executable instructions for computer system 1200. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and disclosed herein. A number of program modules may be stored in drives and RAM 1210, including operating system 1232, one or more application programs 1234, other program modules 1236, and program data 1238. In some examples, the application programs 1234 can include one or more modules (or block diagrams), or systems, as shown and disclosed herein. In some examples, the application programs 1234 includes the tool 100, the real image enhancement model 112 and/or the synthetic image enhancement model 114, as shown in FIG. 1.

A user may enter commands and information into computer system 1200 through one or more input devices 1240, such as a pointing device (e.g., a mouse, touch screen), keyboard, microphone, joystick, game pad, scanner, and the like. These and other input devices are often connected to processing unit 1202 through a corresponding port interface 1242 that is coupled to the system bus, but may be connected by other interfaces, such as a parallel port, serial port, or universal serial bus (USB). One or more output devices 1244 (e.g., display, a monitor, printer, projector, or other type of displaying device) is also connected to system bus 1206 via interface 1246, such as a video adapter.

Computer system 1200 may operate in a networked environment using logical connections to one or more remote computers, such as remote computer 1248. Remote computer 1248 may be a workstation, computer system, router, peer device, or other common network node, and typically includes many or all the elements described relative to computer system 1200. The logical connections, schematically indicated at 1250, can include a local area network (LAN) and a wide area network (WAN). When used in a LAN networking environment, computer system 1200 can be connected to the local network through a network interface or adapter 1252. When used in a WAN networking environment, computer system 1200 can include a modem, or can be connected to a communications server on the LAN. The modem, which may be internal or external, can be connected to system bus 1206 via an appropriate port interface. In a networked environment, application programs 1234 or program data 1238 depicted relative to computer system 1200, or portions thereof, may be stored in a remote memory storage device 1254.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

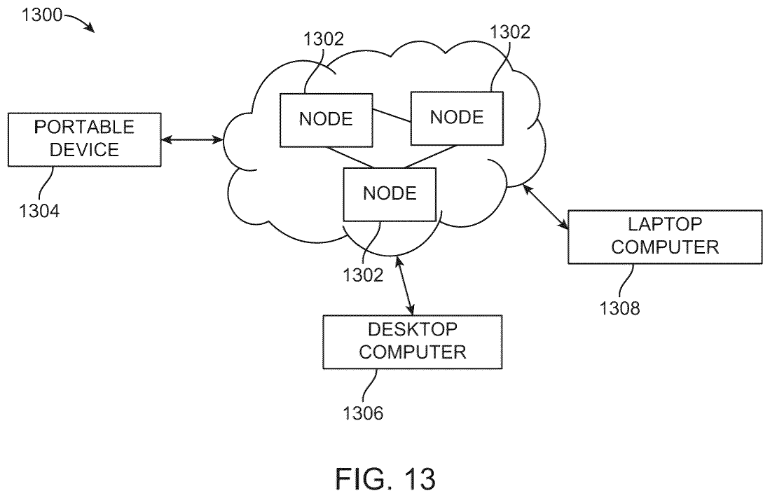

FIG. 13 is an example of a cloud computing environment 1300 that can be used for implementing one or more modules and/or systems in accordance with one or more examples, as disclosed herein. Thus, reference can be made to one or more examples of FIGS. 1-13 in the example of FIG. 13. As shown, cloud computing environment 1300 can include one or more cloud computing nodes 1302 with which local computing devices used by cloud consumers (or users), such as, for example, personal digital assistant (PDA), cellular, or portable device 1304, a desktop computer 1306, and/or a laptop computer 1308, may communicate. The computing nodes 1302 can communicate with one another. In some examples, the computing nodes 1302 can be grouped (not shown) physically or virtually, in one or more networks, such as Private, Community, Public, or Hybrid clouds, or a combination thereof. This allows the cloud computing environment 1300 to offer infrastructure, platforms and/or software as services for which a cloud consumer does not need to maintain resources on a local computing device. The devices 1304-1308, as shown in FIG. 13, are intended to be illustrative and that computing nodes 1302 and cloud computing environment 1300 can communicate with any type of computerized device over any type of network and/or network addressable connection (e.g., using a web browser). In some examples, the one or more computing nodes 1302 are used for implementing one or more examples disclosed herein relating to root-source identification. Thus, in some examples, the one or more computing nodes can be used to implement modules, platforms, and/or systems, as disclosed herein.

In some examples, the cloud computing environment 1300 can provide one or more functional abstraction layers. It is to be understood that the cloud computing environment 1300 need not provide all of the one or more functional abstraction layers (and corresponding functions and/or components), as disclosed herein. For example, the cloud computing environment 1300 can provide a hardware and software layer that can include hardware and software components. Examples of hardware components include mainframes; RISC (Reduced Instruction Set Computer) architecture based servers; servers; blade servers; storage devices; and networks and networking components. In some embodiments, software components include network application server software and database software.

In some examples, the cloud computing environment 1300 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 1300 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 1300, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 1300 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 1300 can provide a workloads layer that provides examples of functionality for which the cloud computing environment 1300 may be utilized. Examples of workloads and functions which may be provided from this layer include mapping and navigation; software development and lifecycle management; virtual classroom education delivery; data analytics processing; and transaction processing. Various embodiments of the present disclosure can utilize the cloud computing environment 1300.

Embodiments disclosed herein can also include:

A. a method comprising: implementing a first training of an ML algorithm using a synthetic training dataset to provide a first model, the synthetic training dataset comprising low-resolution and high-resolution synthetic image pairs; implementing a second training of the ML algorithm using a real training dataset and an output of the first model to provide a second model, the real training dataset comprising real low-resolution images; and enhancing a low-resolution image using the second model to provide an enhanced image of the low-resolution image.

B. a system comprising: one or more computing platforms configured to: train an NN algorithm using a diffusion process based on a synthetic training dataset to provide a first NN model, the synthetic training dataset comprising low-resolution and high-resolution synthetic seismic image pairs; train the NN algorithm using the diffusion process based on a real training dataset and an output of the first NN model to provide a second model, the real training dataset comprising real low-resolution seismic training images; and transform a low-resolution seismic image using the second model to a high-resolution seismic image image.

C. a method comprising: implementing a first training of a machine learning (ML) algorithm using a diffusion process based on a synthetic training dataset to provide a first model, the synthetic training dataset comprising low-resolution and high-resolution synthetic image pairs, the diffusion process being based on BBDM; implementing a second training of the ML algorithm using a real training dataset and an output of the first model to provide a second model for enhancing a low-resolution image to a high-resolution image, the real training dataset comprising real low-resolution training images.

Each of embodiments A through C may have one or more of the following additional elements in any combination: Element 1: wherein the second training comprises: providing a real-low resolution image from the real-low resolution images to the first ML model to generate a predicted real-high resolution image; and training the ML algorithm using the predicted real-high resolution image and the real-low resolution model to provide the second model; Element 2: wherein the ML algorithm is a NN algorithm; Element 3: wherein the first training of the NN algorithm comprises employing a diffusion process to transform over time a high-resolution synthetic image of the synthetic training dataset to a low-resolution synthetic image of the synthetic training dataset to train the NN algorithm to learn a probability distribution associated with the transformation, the probability distribution representing a range of possible low-resolution images that could result from converting a given high-resolution image; Element 4: wherein the diffusion process is implemented according to an input condition, the input condition comprising the low-resolution synthetic image; Element 5: wherein the diffusion process is based on a diffusion model; Element 6: wherein the diffusion model is a BBDM; Element 6: wherein the diffusion process uses a Brownian bridge process of the BBDM to control the transformation of the high-resolution synthetic image to the low-resolution synthetic image; Element 7: wherein the diffusion process is based on or more process parameters that include a transition kernel to control how the diffusion process evolves over time based on the input condition; Element 8: wherein the one or more process parameters further include a reparameterization method to generate samples of a distribution that evolve a current state of the diffusion process toward a next state based on the transition kernel; Element 9: wherein at each time step of the diffusion process, the reparameterization method comprises: sampling from the distribution to obtain a noise parameter; transforming the noise parameter into a sample that aligns with the current state; and evolving the sample toward the next state; Element 10: wherein the diffusion process is based on a BBDM, and the evolving of the sample toward the next state is based on the BBDM and the transition kernel; Element 11: wherein the first training comprises using a sampling method to sample time steps for training the NN algorithm, each sampled time step identifying or being associated with a current low-resolution synthetic image at a respective time step; Element 12: wherein the first training comprises using the current low-resolution synthetic image to train the NN algorithm to optimize parameters of the NN algorithm to provide a first NN model, the first ML model corresponding to the first NN model; Element 13: wherein the sampling method comprises using a first-order DPM for sampling the time steps for training the NN algorithm; Element 14: wherein the diffusion process is implemented according to an input condition, wherein, during training the NN algorithm based on the synthetic training dataset, the input condition is a low-resolution synthetic seismic image from the synthetic training dataset, and wherein, during training the NN algorithm based on the real training dataset and the output of the first NN model, the input condition is a real low-resolution seismic training image from the real training dataset; Element 15: wherein the diffusion process is based on a Brownian bridge diffusion model; and Element 16: wherein the diffusion process is further based on one or more processor parameters that includes a transition kernel and a reparameterization method.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices, and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 5-10% of the indicated number.

What has been described above includes mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

The invention claimed is:

1. A method comprising:
implementing a first training of a machine learning (ML) algorithm using a synthetic training dataset to provide a first model, the synthetic training dataset comprising low-resolution and high-resolution synthetic image pairs;
implementing a second training of the ML algorithm using a real training dataset and an output of the first model to provide a second model, the real training dataset comprising real low-resolution images; and
enhancing a low-resolution image using the second model to provide an enhanced image of the low-resolution image.

2. The method of claim 1, wherein the second training comprises:
providing a real-low resolution image from the real-low resolution images to the first ML model to generate a predicted real-high resolution image; and
training the ML algorithm using the predicted real-high resolution image and the real-low resolution model to provide the second model.

3. The method of claim 1, wherein the ML algorithm is a neural network (NN) algorithm.

4. The method of claim 3, wherein the first training of the NN algorithm comprises employing a diffusion process to transform over time a high-resolution synthetic image of the synthetic training dataset to a low-resolution synthetic image of the synthetic training dataset to train the NN algorithm to learn a probability distribution associated with the transformation, the probability distribution representing a range of possible low-resolution images that could result from converting a given high-resolution image.

5. The method of claim 2, wherein the diffusion process is implemented according to an input condition, the input condition comprising the low-resolution synthetic image.

6. The method of claim 4, wherein the diffusion process is based on a diffusion model.

7. The method of claim 6, wherein the diffusion model is a Brownian bridge diffusion model (BBDM).

8. The method of claim 7, wherein the diffusion process uses a Brownian bridge process of the BBDM to control the transformation of the high-resolution synthetic image to the low-resolution synthetic image.

9. The method of claim 5, wherein the diffusion process is based on or more process parameters that include a transition kernel to control how the diffusion process evolves over time based on the input condition.

10. The method of claim 9, wherein the one or more process parameters further include a reparameterization method to generate samples of a distribution that evolve a current state of the diffusion process toward a next state based on the transition kernel.

11. The method of claim 10, wherein at each time step of the diffusion process, the reparameterization method comprises:
sampling from the distribution to obtain a noise parameter;
transforming the noise parameter into a sample that aligns with the current state; and
evolving the sample toward the next state.

12. The method of claim 11, wherein the diffusion process is based on a Brownian bridge diffusion model (BBDM), and the evolving of the sample toward the next state is based on the BBDM and the transition kernel.

13. The method of claim 4, wherein the first training comprises using a sampling method to sample time steps for training the NN algorithm, each sampled time step identifying or being associated with a current low-resolution synthetic image at a respective time step.

14. The method of claim 13, wherein the first training comprises using the current low-resolution synthetic image to train the NN algorithm to optimize parameters of the NN algorithm to provide a first NN model, the first ML model corresponding to the first NN model.

15. The method of claim 13, wherein the sampling method comprises using a first-order diffusion probabilistic model (DPM) for sampling the time steps for training the NN algorithm.

16. A system comprising:
one or more computing platforms configured to:
train a neural network (NN) algorithm using a diffusion process based on a synthetic training dataset to provide a first NN model, the synthetic training dataset comprising low-resolution and high-resolution synthetic seismic image pairs;
train the NN algorithm using the diffusion process based on a real training dataset and an output of the first NN model to provide a second model, the real training dataset comprising real low-resolution seismic training images; and
transform a low-resolution seismic image using the second model to a high-resolution seismic image image.

17. The system of claim 16,
wherein the diffusion process is implemented according to an input condition,
wherein, during training the NN algorithm based on the synthetic training dataset, the input condition is a low-resolution synthetic seismic image from the synthetic training dataset, and
wherein, during training the NN algorithm based on the real training dataset and the output of the first NN model, the input condition is a real low-resolution seismic training image from the real training dataset.

18. The system of claim 16, wherein the diffusion process is based on a Brownian bridge diffusion model.

19. The system of claim 18, wherein the diffusion process is further based on one or more processor parameters that includes a transition kernel and a reparameterization method.

20. A method comprising:
implementing a first training of a machine learning (ML) algorithm using a diffusion process based on a synthetic training dataset to provide a first model, the synthetic training dataset comprising low-resolution and high-resolution synthetic image pairs, the diffusion process being based on a Brownian bridge diffusion model (BBDM);
implementing a second training of the ML algorithm using a real training dataset and an output of the first model to provide a second model for enhancing a low-resolution image to a high-resolution image, the real training dataset comprising real low-resolution training images.
